(19) United States
(12) Patent Application Publication
(10) Pub. No.: US 2020/0049844 A1
(43) Pub. Date: Feb. 13, 2020

(54) COMPUTER IMPLEMENTED METHOD FOR IMPROVING A VELOCITY MODEL FOR SEISMIC IMAGING

(71) Applicant: REPSOL EXPLORACIÓN, S.A, Madrid (ES)

(72) Inventors: Germán LARRAZÁBAL, The Woodlands, TX (US); José OMANA, The Woodlands, TX (US)

(21) Appl. No.: 16/490,275

(22) PCT Filed: Mar. 1, 2018
(86) PCT No.: PCT/EP2018/055066

§ 371 Date: Aug. 30, 2019

(30) Foreign Application Priority Data
Mar. 1, 2017 (EP) 17382106.7

(51) Int. Cl. G01V 1/28; G06T 5/00; G06T 5/50

(52) U.S. Cl. CPC G01V 1/282; G01V 2210/51; G06T 5/50; G06T 5/002

(57) ABSTRACT

The present invention is in the field of seismic imaging of underground structures. The invention is a method for solving the uncertainty and instability generated in reservoir geometries due to salt bodies which causes the presence of artifacts in the velocity fields. The method is based in a desalting process and a further specific reconstruction of the sediments located in the domain of the image. Desalting means to remove salt volumes located within the domain wherein said process is followed by the replacement of good sediment velocity values and a careful iterative process avoiding the generation of artifacts.

### FIELD OF THE INVENTION

The present invention is in the field of seismic imaging of underground structures. The invention is a method for solving the uncertainty and instability generated in reservoir geometries due to salt bodies which causes the presence of artifacts in the velocity fields.

The method is based in a desalting process and a further specific reconstruction of the sediments located in the domain of the image. Desalting means to remove salt volumes located within the domain wherein said process is followed by the replacement of good sediment velocity values and a careful iterative process avoiding the generation of artifacts.

### PRIOR ART

In oil and gas exploration, seismic surveys are used to estimate features of interest of subsurface geology such as fractures, discontinuities in rock properties in stratified structures or regions storing gar or oil.

Seismic surveys use controlled seismic energy, such as produced by specialized air guns or seismic vibrators.

After applying acoustic waves to a determined region, the domain to be explored, for instance by means of the air guns or seismic vibrators, a plurality of receivers sense seismic energy, typically in the form of an acoustic waves, reflected by subsurface features, mainly discontinuities of the acoustic properties of the rock. The subsurface features are detected by analyzing the time it takes for reflected seismic waves to travel through the subsurface matter of varying densities. 3-D seismic also uses seismic energy to produce a 3-dimensional map of subsurface formations.

Many conventional preprocessing workflows were developed in the days prior to the availability of complex imaging algorithms resulting in an inappropriate processing.

For describing adequately the geologic reality it is necessary to address large scale and crystalline structure, rheology, and anisotropy. Most of the time, there is insufficient information (measured data) to adequately describe the anisotropic behavior of the subsurface, hence great ambiguity and/or uncertainty remains concerning anisotropy.

Once a prospect has been identified, an exploration well is drilled in an attempt to conclusively determine the presence or absence of oil or gas. However, an exploratory well can be very expensive especially for off-shore wells and the retrieved information is limited to the path defined by the trajectory of the well within the reservoir.

Imaging the reservoir by means of acoustic techniques combined with the migration processing of the retrieved images provides very valuable information for the entire domain.

The domain to be explored is being represented by an image over a discrete domain, comprising voxels if the domain is a 3D space or pixels if the domain is a 2D space, wherein each voxel/pixel represents the propagation velocity of the rock at the location of said voxel/pixel. There is a close relationship between the rock properties and the propagation velocity and therefore the propagation velocity field is a specific manner of describing and identifying the rock material in the domain.

As the velocity depends on the rock properties, the image allows identifying the shape and distribution of the rock properties. The comparison between the velocity field in the domain represented by the image and known velocity properties of rocks provides an identification of the geological structures in the region being explored. Therefore, the image is a numerical model representing the geological structure of a region of the subsurface.

Such numerical model allows in a further stage the simulation of perforation or exploitation processes in order to reach an optimal plan. Said subsequent simulations need accurate images or numerical models for reducing the uncertainty.

Seismic imaging of evaporite bodies is notoriously difficult due to the complex shapes of steeply dipping flanks, adjacent overburden strata, the usually strong acoustic impedance and velocity contrasts at the sediment-evaporite interface and the lack of reflectivity inside of evaporite bodies.

Salt movement often results in steeply dipping complex-shaped structures that pose significant challenges for seismic velocity model building and seismic migration.

Migration of seismic data moves dipping events to their correct positions, collapses diffractions, increases spatial resolution and is probably the most important of all processing stages. Migration theory has been long established but restricted computer power has driven the industry to a bewildering array of ingenious methods to perform and enhance the accuracy of migration while keeping reasonable computational cost. Because of the high computational cost limitations, it could be argued that much of the past research has been directed towards doing migration less wrong rather than doing it right. Certainly there has been more research into migration algorithms than the critical factor of determining the correct velocity model to use.

One of the most used theories of migration of seismic data is the zero-offset migration. This method simulates a stack process as well as attenuating noise and multiples. The migration process is referred to as poststack migration or zero-offset migration. If the stack does not produce a good approximation to the zero-offset section then prestack migration must be performed prior to stacking. Due to the data volumes involved, prestack migration takes at least the fold of the data longer to compute than poststack migration. The main problem of this method is that the zero offset seismic data are derived by processing normally acquired seismic data using geophysical algorithms instead of directly acquiring in the field un-efficiently. In addition, the computational cost for pre-stack migration is extremely high due to the data volumes involved.

Recent advances in seismic imaging algorithms have permitted imaging of steep structures by exploiting the two-way wave equation using reverse time migration (RTM). With such imaging algorithms, double bounces and turning-wave reflections can be used to image vertical and overturned salt flanks. However, despite advances in migration algorithms, the derivation of an acceptably realistic earth model incorporating the anisotropic behavior of the velocity field remains a significant challenge, requiring tight integration of geologic interpretation and geophysical skills.

The current industrial state-of-the-art practice of using acoustic migration is still only acoustic and it ignores mode conversion at interfaces, resulting in treating such energy as noise, which contaminates the image and misleads the interpreter by contaminating the final images and parameter estimations.

Another problem for considering is that conventional preprocessing workflows are developed without taking into account the vicinity of complex structures. This is due to travel paths of sound in the vicinity of complex geometries are very complicated, often making it extremely difficult to make sense of the data they are working with. This problem is the outstanding importance for adequately describe geologic reality, in special for diagenesis and cap rock formation in salt bodies. Often, the conventional methods oversimplify the salt cap structures, especially if the cap material is thin or confused with flank sediments. This can distort the final image because it would be using inappropriate velocities in the vicinity of the salt.

Building salt regions with depth imaging, it is often assumed that the evaporate body is pure halite with a constant compressional wave speed. However, almost all salt bodies contain varying amounts of gypsum or anhydrite, and some bodies contain significant amounts of K—Mg-rich salts with low seismic velocities. In addition, other factors such as bound water also affect the sound speed. Furthermore, a thick (up to 400 m) anhydrite cap rock can develop over the crest and flanks of a salt diapir due to salt dissolution, which leaves an anhydrite residue.

When salt flows into a salt body the flow rates vary due to local heterogeneities in the salt and variable salt thickness. Flow instability leads to folding of the salt layers even if there is very little rheological contrast between layering.

Individual interbeds of anhydrite and dolomite may also increase velocity anisotropy within the evaporite body if they remain as intact layers over large areas. However, it is not known whether the seismic velocity anisotropy of longer wavelength seismic waves is important in layered salt bodies. So far, there has been little attempt to incorporate salt anisotropy into velocity model building.

The result of the presence of these complex structures near the evaporate bodies and the limitation of the migration algorithms when processing acoustic data obtained from domains having salt bodies with very different propagation velocities when compared with the rest of the rock materials is the presence of artifacts surrounding said salt or evaporate bodies.

These artifacts are identified as high frequency wrinkles or spurious velocities distorting the image around the salt body and providing a wrong interpretation of the rock near the interface and under said salt body.

Once artifacts appear in the image, the use of any subsequent numerical process trying to improve the image by using an iterative method according to the prior art fails as artifacts are instabilities that remain in the image through the processing by any iterative process.

Therefore, there is a need for improving the seismic velocity field in an image representing a domain providing a velocity field with no artifacts around salt bodies and a correct velocity in the vicinities and under said salt bodies.

### DESCRIPTION OF THE INVENTION

The present invention is a method that includes an extrapolation preserving the structural geometry of the sedimentary model surrounding the salt area for solving the uncertainty created by autochthonous and foreign salt geometry which causes the presence of artifacts in the velocity fields.

A major factor in the successful execution of a complex salt imaging project is the understanding of the many and varied pitfalls involved at every stage of the process such as seismic velocity anisotropy, P- and S-wave mode conversion, complex ray paths and reflected refractions.

The critical part of the processing sequence for seismic imaging, in particular 3D seismic imaging, is the velocity building model considering that it defines the structural geometry of the subsurface image.

The ray tracing tomography velocity inversion is a mature technology and widely used in industry for velocity update but this iterative method is very sensitive to the initial velocity model.

Any iterative numerical method having a unique solution and being convergent reaches the solution independently of the initial condition given that said initial condition is in the space of values where convergence is being ensured. However, once artifacts appear in the image the instabilities are not damped during the iterative process and the iterative method does not converge to the numerical solution lacking of the artifacts.

The invention provides a method for building a good image representing a numerical velocity model. The resulting image may be used for instance for at least the first iteration of tomographic velocity. The obtained image lacks of artifacts and departs from an approximation, a first image, that may already have artifacts.

The departing velocity model has all the interpreted salt in place and is historically plagued with spurious velocities under the salt overhangs.

Therefore, in order to build a stable initial velocity model for the sediments, the invention carry out a desalting process to remove salt and anomalous velocities and replace them with a velocity sediment trend.

The present invention provides a computer implemented method that includes an extrapolation preserving but improving the structural geometry of the sedimentary model surrounding the salt area. The computer implemented method comprises a migration module wherein the migration module (M) is adapted to migrate the acoustic field data (AD) to correct a seismic image (I) iteratively, the seismic image (I) comprising voxels/pixels representing the velocity model of a region of a subsurface region wherein said migration module (M) at least returns the velocity correction (Δv) of an seismic image (I) by carrying out a predetermined number of iterations n.

Seismic migration is the process that converts information as a function of recording times provided by the acoustic field data (AD) to features in subsurface depth. Rather than simply stretching the vertical axes of seismic sections from a time scale to a depth scale, migration aims to put features in place by means of an iterative method, for instance by ray tracing. Each iteration improves the velocity field providing velocity corrections (Δv) for each pixel. A seismic image (I) is therefore improved when corrected by incrementing the values of the image with the corrections (Δv).

In the current stage, the provided migration module (M) is adapted to carry out a predetermined number of iterations n migrating the image, providing in each iteration an individual correction and, after said n iterations the accumulated correction (Δv).

This migration module (M) may be any implementation of the iterative migration methods according to the prior art. Such a module may be used to obtain a velocity model departing from an initial value and may be good enough if no salt regions are in the domain. During the iterative process, each velocity field represented by the image, starting with the initial value; that is, an initial proposed image, and is corrected by performing a predetermined number of iterations, for instance by means of the provided migration module (M), until a stop criterion identifying the convergence of the approximated solution is reached.

That is, for any iteration, a velocity correction is performed in the migration module (M) and the new value of the velocity model updated in the seismic Image (I).

The computer implemented method, according to an aspect of the invention comprises the following steps:
a) recording seismic waves at the earth's surface being acquired as acoustic field data (AD);
b) departing from an initial proposed image converting acoustic field data (AD) by the migration module (M), through a predetermined number of iterations, into an estimated seismic image (I) comprising voxels/pixels representing the velocity model of a region of the subsurface region.

At the first stage of the method a seismic image (I) is generated. Seismic imaging is a tool that bounces sound waves off underground rock structures to reveal possible crude oil and natural gas bearing formations. It is a picture of subsurface structure from the seismic waves recorded at the earth's surface. It enables exploration in areas with complex structures lying below complex overburden, such as sub-salt exploration. The seismic waves recorded at the earth's surface are identified as acoustic field data (AD).

The acquired acoustic field data (AD) are used to migrate the image of the subsurface structures according to any of the available algorithms in the prior art, for instance by solving the Kirchhoff equations.

As earlier stated, building the velocity model is a critical part of the processing sequence since it defines the structural geometry of the subsurface image both for 2D and for 3D seismic imaging.

The image is defined in a domain representing a region of the subsurface, for instance a region comprising an oil/gas reservoir. The scalar represented by each pixel/voxel is the velocity of propagation at the location associated to said pixel/voxel within the domain. As a predetermined relationship between a velocity value and a type of rock having said velocity value or a range of velocity values comprising the velocity value is known in the art; the pixel/voxel may indistinctly represent the velocity value or certain rock.

Therefore, the velocity field is a scalar that can be presented graphically establishing a color palette that defines a functional relation between the values of the velocity and a predefined set of colors or color palette.

Depending which kind of seismic image (I), in two- or three dimensions is provided at this first stage, the information related to said velocity model and said acoustic data (AD) will be represented in a pixel or a voxel, where said pixel is the smallest element of an image that can be individually processed, and said voxel represents a value on a regular grid in three-dimensional space. The image is then a numerical approximation to the subsurface structure represented in a discretized domain.

An example of data structure for storing the velocity field is a structured 3D where each component of the structured matrix is a cell that at least comprises the velocity value. In such case, there is a one-to-one relationship between the stored velocity and the colors with said represented velocity field. This type of store structure data allows an easy interpretation, by an expert on the matter, of the geological structure established by the velocity field. In addition, stored values ensures a computer processing data to distinguish between different materials by comparison with a database in which each stored material in said database define, as one of the properties of the material, the range of acoustic propagation velocity values.

The use of the migration module (M) allows computing the correction of the velocity in each pixel/voxel in each iteration. This correction is applied to each pixel/voxel of the image for each iteration and, as a result, the iteration process provides the estimated seismic image after convergence.
c) identifying in the seismic image (I) at least one salt region D1, at least one artifacts region D2, and at least one region D3 with no salt or artifacts.

Once the migration module is established, the next step is to identify the different regions in the domain of said seismic image. The salt bodies are defined by the criteria of the expert salt interpreters for instance by identifying the range of velocity values corresponding to salt properties. The salt region identification, once the criteria has been specified, can automatically identified for instance by a computer system.

According to a particular embodiment, this step may be modified by a user interacting with the computer system using a user interface. This user interaction can be also used for adding new regions D1, D2 or D3 identified by the user but not automatically identified by the computer system.

Artifacts are shown as wrinkled regions because the instabilities. According to an embodiment, these regions are automatically identified by checking regions having fluctuations with high frequency components in the frequency domain or regions with a noise value over a predetermined threshold.

According to the preferred embodiment, regions D1, D2 and D2 are disjointed regions and the union of D1, D2 and D3 is the entire domain of the image.

All the regions identified as salt region in said seismic imagine (I) are identified as al and the region without any evidence from the salt region is named D3. In addition, due to the difficulty to determine exactly the salt region, according to another embodiment the artifact regions D2 are located surrounding D1 for instance by expanding the region D1.

Region D3 may be determined as the entire domain eliminating regions D1 and D2.

In this stage three different volumes are loaded according with the region identification criteria detailed above.
d) removing the voxels/pixels of the at least one salt region al and the at least one artifacts region D2 from the seismic image (I).

The velocity model providing the first seismic image in the first step has all the main interpreted salt in place and is historically plagued with spurious velocities under salt overhangs if said overhangs exist.

In some cases, for example in deep water geologically complex areas, users have to start from a legacy velocity model which has all salt in place from a previous depth processing sequence. This processing sequence provides images with salt regions having anomalous velocities which do not represent the real sediment geological structure.

Therefore, in order to build a velocity model free of artifacts and representing accurately sediments and other geological structures, according to the instant invention a desalting process is applied removing salt and anomalous velocities.

This desalting process is execute in this stage by removing the voxels/pixels that represent said seismic image (I) from at least one of said salt regions al, obtaining a velocity volume without salt in place. The same process is applied to at least one of said artifact regions D2.

According to a particular embodiment, removing pixels from the image may be carried out by creating a mask representing the void volume of the salt regions even if the pixels values on that regions have not been modified or removed for instance by feeing the memory allocated for the storage of the pixels/voxels.

In this particular case, when the entire image or a particular region of said image is being processed, pixels and voxels being within the mask region are deemed as not being in the image. Another advantage of this particular implementation is that no management of memory allocation or disposal is being needed for this removal and further operation filling the free space can re-use pixels/voxels already allocated and identified by the mask.
e) filling the at least one salt region al and the at least one artifacts region D2 of the seismic image (I) with voxels/pixels with velocity values interpolated from the velocity values of the at least one region D3 with no salt or artifacts.

Even if most of the region comprising D1 and D2 comprises salt, said regions previously removed are not filled with salt but they are filled with values interpolated from the rest of the domain which corresponds to velocity values that are not identified as salt.

As the rest of the domain does not comprises salt because the removal, the filling with voxels/pixels by interpolation avoid the filling of salt velocities avoiding relevant velocity gradients within the image that may generate artifacts.

According to an embodiment, after the desalting process executed in the previous stage, a smart smoothing is applied to remove salt footprint without altering original sediment velocities present in the vintage volume.
f) generating a velocity correction Δv for each pixel/voxel migrating the acoustic field data (AD) seismic image (I) with the image obtained in step e) by means of the migration module (M) carrying out a predetermined number of iterations n.

A correction of the velocity model obtained previously is carried out by performing in a computer system a predetermined number of iterations n in the provided migration module (M). As the migration is carried out by using the acoustic field data (AD) which has been obtained from a domain comprising salt regions, at least regions D1, after updated with the corrections obtained by the migration process, evolves to scalar values representing salt but being free of artifacts because the local treatment and the previous removal of artifacts. The velocity correction for each pixel/voxel identified as Δv may be interpreted as the increment or correction of the velocity in the pixel/voxel and may be a different value of the correction of the velocity corresponding to any other pixel/voxel of the image.
g) updating the at least one salt region D1 and the at least one region D3 with no salt or artifacts with the velocity correction Δv for each pixel/voxel of said regions;
h) updating the artifacts region D2 with a limited velocity correction Δv for each pixel/voxel of said regions, the limited velocity correction Δv being:
   or a bounded velocity correction; that is, the correction Δv if |Δv|<Δₘₐₓ being Δₘₐₓ a positive predetermined bound or the correction sign(Δv)·Δₘₐₓ if |Δv|≥Δₘₐₓ being sign(Δv) de sign of Δv,
   or a damped velocity correction λΔv, being λ∈(0,1) a predetermined value.

The salt regions reappears as it has been disclosed above because that the correction values determined by means of the migration module is based on acoustic field data (AD) obtained from a domain having salt. D1 comprising salt is being corrected in such manner that velocity values of salt are recovered but artifact region is treated in a separated manner limiting the corrections and therefore avoiding the appearance of artifacts due to instabilities of the iterative method.
i) providing the seismic image (I) corrected in the previous step.

As a result a final velocity model with all salt in place and without artifacts is provided.

According to an embodiment, the group of steps f)-h) may be repeated executing one or a small amount of iterations n in each individual step f), computing the migration module over a partially corrected image. That is, rather than obtaining the correction in one step and then updating the image, in particular D1 and D2, a smoother process computes a small correction by the computation of 1 or a small number of individual interaction, applies such a correction and subsequent small corrections are computed by means of the migration module (M) using the already partially corrected image.

In any case, region D2 is updated with a limited velocity correction Δv.

A limited correction over the artifacts region D2 may be represented as correcting pixels/voxels with a value λΔv, being λ an scalar value ranging the interval (0,1). The λ is identified as a damping parameter. An alternative correction of each pixel/voxel is taken by applying an upper bound for Δv. If the absolute value of the correction is greater than a predetermined bound Δₘₐₓ then the correction Δv is then limited to a bounded value of said correction.

### DESCRIPTION OF THE DRAWINGS

These and other features and advantages of the invention will be seen more clearly from the following detailed description of a preferred embodiment provided only by way of illustrative and non-limiting example in reference to the attached drawings.

FIG. 1 This figure shows a data processing system for carrying out a method according to the invention.

FIG. 2 This figure shows schematically an example of a prior art process and a subsequent processing of the image according to the invention.

FIG. 3 This figure shows a starting velocity model in the form of an image being computed by using a migration algorithm according to the state of art. The velocity field shown in this figure is used as the image to be processed according to an embodiment of the invention.

FIG. 4 This figure shows some areas of the image turned to black color for identifying at least some salt bodies.

FIG. 5 This figure shows an intermediate step according to an embodiment of the invention wherein the image has been split in three regions D1, D2 and D3.

FIG. 6 This figure shows the removal workflow result applied to the image of the same embodiment.

FIG. 7 This figure shows a filling process in the removed regions by using an interpolation of the surrounding velocity values.

FIG. 8 This figure shows the corrected image after migrating the image applying a selected correction.

FIG. 9 This figure shows the Reverse Time Migration (RTM) using the state of art depth velocity model.

FIG. 10 This figure shows the Reverse Time Migration (RTM) obtained by using a method according to the invention.

### DETAILED DESCRIPTION OF THE INVENTION

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to illustrations and/or diagrams of methods, apparatus (systems) and computer program products according to embodiments of the invention. It will be understood that each illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

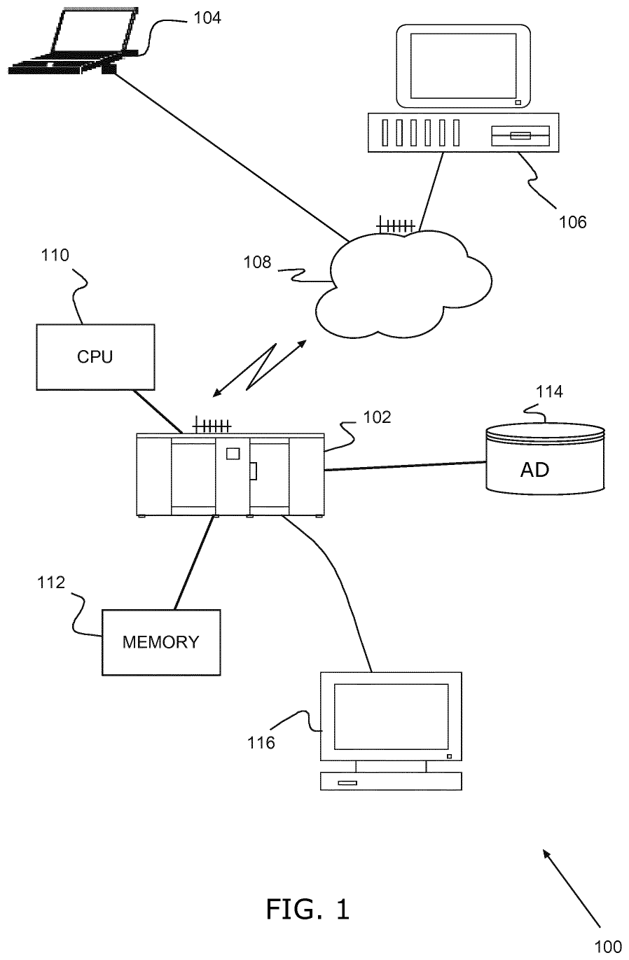

Turning now to the drawings and more particularly, FIG. 1 shows an example of a system 100 improving a velocity model for seismic imaging departing from acoustic field data (AD), according to a preferred embodiment of the present invention.

The preferred system 100 improves a velocity model in the form of an image (I) in an efficient manner comprising the sequential process of taking first approximation of the numerical model in the form of a migrated image, identifying salt bodies D1, artifacts and regions comprising instabilities or inaccurate structures D2 and the rest of the domain. A further step removes pixels/voxels located within regions D1 and D2, being replaced by values interpolated by using pixels/voxels of region D3.

These two steps are carried out in the computer system (110) and such a computer system (110) executes an instantiated migration module (M) for determining a velocity correction Δv of pixels/voxels of D1, D2 and D3. Said computer system (110) is adapted to carry out a selected correction wherein at least D2 is being updated by a limited correction Δv.

A preferred computing system 100 includes one or more computers 102, 104, 106 (3 in this example), coupled together, e.g., wired or wirelessly over a network 108. The network 108 may be, for example, a local area network (LAN), the Internet, an intranet or a combination thereof. Typically, the computers 102, 104, 106 include one or more processors, e.g., central processing unit (CPU) 110, memory 112, local storage 114 and some form of input/output device 116 providing a user interface. The local storage 114 may store the acoustic field data being accessible by the plurality of computers 102, 104, 106, processing in parallel a plurality regions of the image in an efficient manner, or processing in parallel a parallel version of the migration module (M), each individual process being processed by each computer 102, 104, 106.

The present invention provides a method for solving the uncertainty generated in reservoir geometries mainly due to salt bodies.

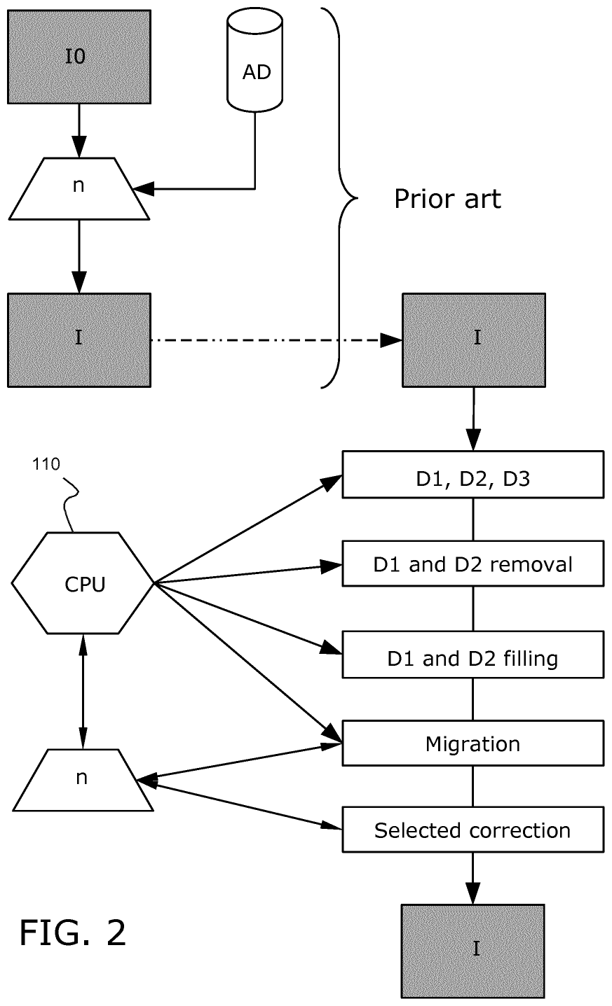

Turning now to FIG. 2, according to the prior art, acoustic field data (AD) is used as the main source data for generating by migration the image (I) of the domain to be explored. The image is the representation of a scalar field, the velocity of propagation, where each pixel/voxel represents the velocity at a location at the discrete domain, the location within the domain of the subsurface associated to said pixel/voxel.

The migration process is an iterative method providing a sequence of images converging to the numerical approximation of the scalar field corresponding to the velocity of the explored domain. As it has been disclosed in the prior art section, there are well known algorithms allowing an efficient method for migrating the acoustic field data (AD). Even if the convergence properties of the migration module (M) ensures that the image obtained does not depends on the initial values; an approximate image reduces the time processing for reaching the image when convergence criteria is met. Typical convergence criterion is the measurement of the difference between two consecutive images being measured once a certain norm has been predefined.

Even if the final image is the result of an iterative process repeated until the convergence criterion is met, a certain predefined number of iterations can be carried out. In this particular embodiment, the migration module (M) is a module that can be instantiated within a program wherein the number of iterations is a parameter. When the migration module is called with a number of iterations n, the module only execute n iterations on the image.

According to this embodiment, this migration module (M) identified in FIG. 2 implementing a method according to the prior art is adapted to iterate on the image by using two steps, a first step determining the correction Δv and a second step updating the velocity values of the image with the correction Δv. A particular embodiment of this method according to the prior art, in each iteration the updating process is immediately executed after the first step, that is, after the correction has been determined.

If artifacts appear in the image during the iteration process from the initial image (10) to the final image (I) by using the acoustic field data (AD), said artifacts cannot be removed by any iterative migration methods known in the prior art.

A similar migration module (M) is being represented in FIG. 2 in an embodiment of the present invention, shown in the lower part. In this particular case, the migration module (M) is adapted to carry out one or more iterations determining the correction Δv and, the same migration module (M) is adapted to carry out the updating of the image in a specific manner as it will be disclosed below.

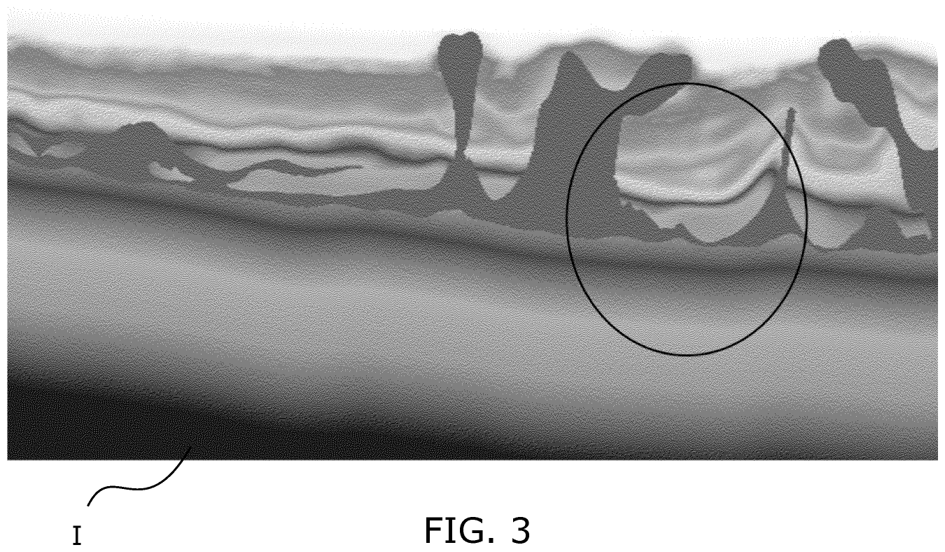

The explanation of the method represented by the scheme shown in FIG. 2 and according to an embodiment of the present invention will be combined with images shown in FIGS. 3-8.

In order to build a stable initial velocity model for the sediments and the salt bodies, the starting seismic image (I) is the image obtained by using a migration algorithm using the acoustic field data (AD), for example the final depth interval velocity model provided by any migration algorithm provided by the state of art. The initial image, according to this embodiment is taken as the result of a migration process as shown in FIG. 2.

FIG. 3 shows an embodiment of initial seismic image (I), this starting seismic image (I) has not the interpreted salt bodies in the right location and is historically plagued with spurious velocities appearing as numerical instabilities being shown as wrinkles surrounding salt bodies or other spurious velocities under salt overhangs. The origin of such anomalous velocities could be related to velocity picking in the time domain, where the presence of salt bodies limits what can be achieved by 1D velocity analysis on semblance panels.

Seismic image (I) shown in FIG. 3 comprises voxels/pixels representing the velocity of propagation in each location determined by said voxel/pixel. The image uses a color palette for identifying the velocity field. Color palette allows a graphical identification of the velocity of propagation of the rock.

Salt bodies (SB) are clearly identified as the areas with almost no gradients. Said salt bodies may be identified numerically when the velocity of each pixel/voxel is compared with the propagation velocity stored in a data bases storing rock properties.

FIGS. 3 to 8 shows an oval highlighting the region located under a salt overhang where the migrated velocities under the overhangs and also the anomalous high velocities observed at the narrow basins in between steeply dipping salt flanks are not accurately determined according to a prior art method. Those high velocity anomalies correspond to unconstrained tomographic velocity updates for geometry.

A dramatically slowdown is shown in the base of salt for the overhang creating unnaturally high velocities for the deeper part of the section. This harsh slowdown in velocity has no justification and degrades the imaging.

In order to obtain a good velocity model the initial velocity model is corrected according to an embodiment of the invention.

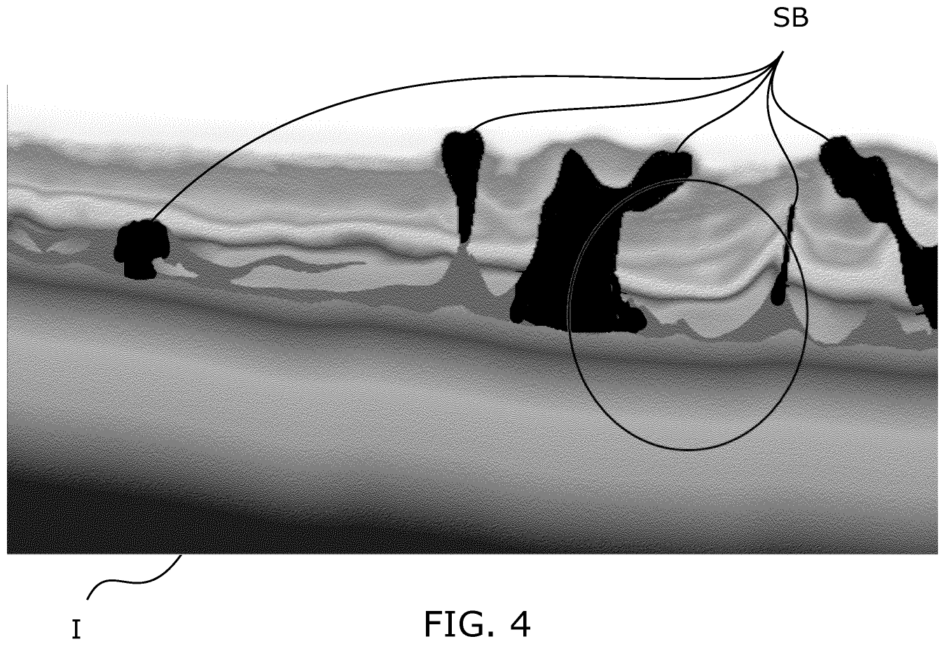

Departing from the seismic image (I), salt regions are identified. FIG. 4 is the seismic image (I) showing in black some regions identified as salt bodies (SB). In a preferred embodiment, regions are identified by creating a mask over-imposed over the original image.

Those pixels-voxels coinciding with the mask are deemed to be comprised within the region defined by the mask.

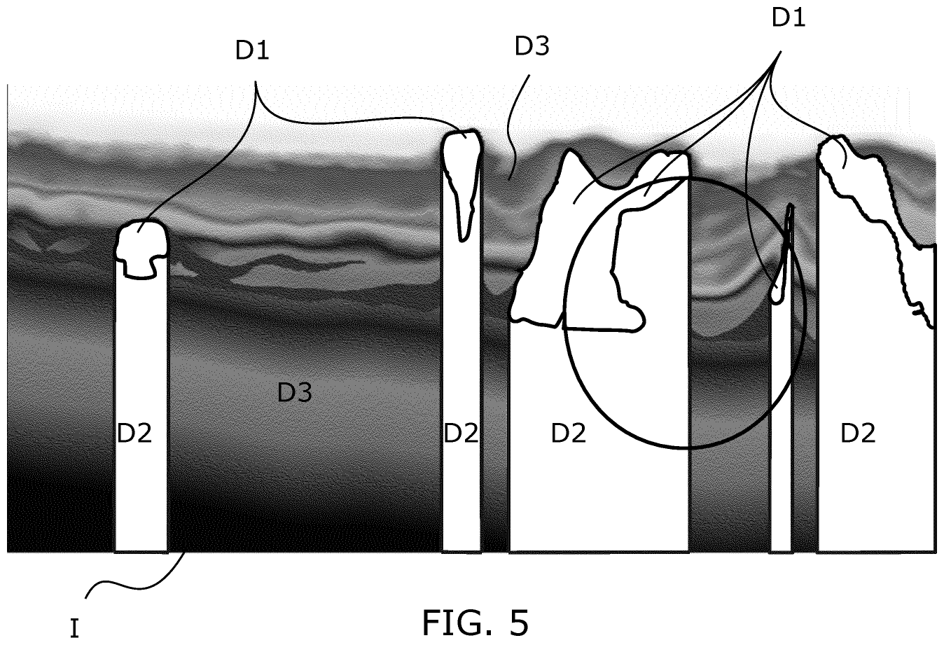

FIG. 5 shows a subsequent step wherein the image is separated in three different regions, a first region D1 of salt bodies (SB) already identified in FIG. 4, a second region D2 having artifacts which appears as being the set of pixels/voxels located below region D1. According to another embodiment, the second region D2 having artifacts is expanded including the surroundings of the salt bodies (SB). The rest of pixels/voxels are identified as the third region D3.

FIG. 5 shows the first region D1 and the second region D2 identified as separated masks, each mask having non-connected regions, and the third region D3 is not represented by an specific mask as it may be identified as the region not being within the mask of D1 or the mask of D2.

In a further step, pixels/voxels being within the first region D1 and within the second region D2 are removed from the seismic image (I).

In one embodiment, pixels/voxels being in both regions are disposed freeing the memory. In a preferred embodiment, pixels located within the mask of D1 and D2 are identified by a property value as being removed while said pixels are being kept in memory (112). If this set of pixels/voxels is generated again, the property associated to those pixels/voxels is changed and no additional memory management is needed for disposing and allocating new segments of memory.

According to an embodiment of the invention, regions being removed are generated by filling pixels/voxels using an interpolation method by using the pixel/voxels values of region D3 ending up with regions D1 and D2 having velocities that do not show high gradients or artifacts that may deteriorate any subsequent iterative migration.

In a preferred embodiment, interpolation method reproduces a stratigraphic deposition filling region D2 and also region D1 even if said first region D1 comprises salt bodies according to the acoustic field data.

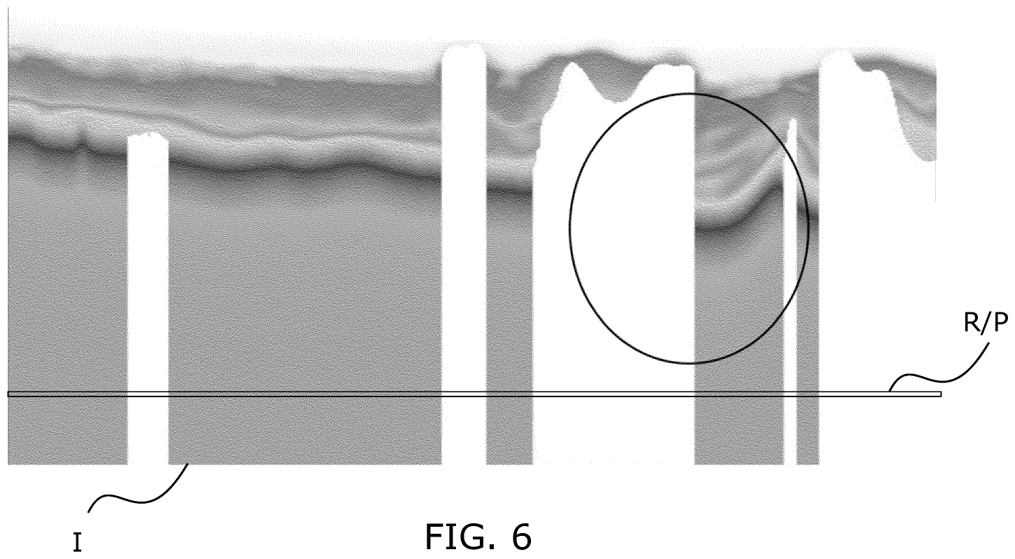

The seismic image (I) shows rows and columns of pixels if the image is two-dimensional, or vertically stacked planes of voxels if the image is a three-dimensional image. FIG. 6 shows a determined row/plane identified as R/P being extended horizontally.

This filling process comprises:
for each plane/row of voxels/pixels of the seismic image (I) comprising at least one voxel/pixel removed, interpolate the removed voxels/pixels by using the velocity values of voxels/pixels of the same plane/row corresponding to the at least one region D3 with no salt or artifacts.

After this process a stratified structure is reproduced with velocities similar to those of the vicinity. In a preferred embodiment, after interpolating the removed pixels/voxels, a smoothing step involving voxels/pixels of the same plane/row is applied, in particular by means of a Natural Neighbor algorithm. This smoothing process damps sharp gradients in the horizontal direction generated in the filling process.

In a further embodiment, a smoothing step over the entire image (I) is applied. This smoothing process allows a diffusion process wherein the velocity is also propagated vertically reproducing vertical variations even in stratified structures.

A further embodiment improves the vertical diffusion of the velocity values improving the identification of complex structures not being horizontal. A further smoothing step over the entire seismic image (I) is carried by:
generating a second image with the same number of voxels/pixels, each voxel/pixel having the value 1/v of the corresponding velocity value v of the voxel/pixel of the seismic image (I);
carrying out the smooth step over the second image;
providing the seismic image (I) wherein each voxel/pixel takes the inverse value of the corresponding voxel/pixel of the second image.

In a preferred embodiment, as defined above, the smoothing step over the entire image is carried out by a damped least square algorithm.

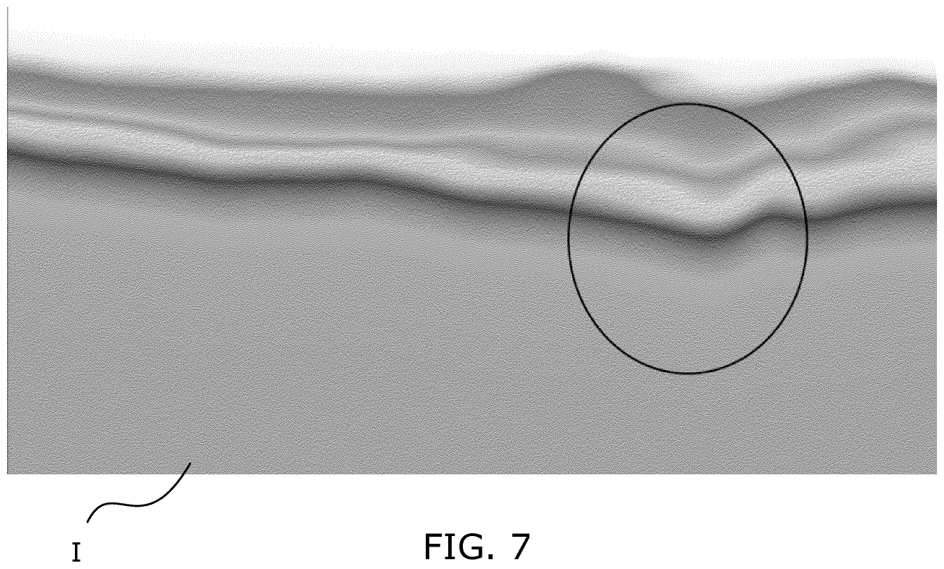

FIG. 7 shows the final result after filling the removed pixels and after a complete smoothing process. A stratigraphically structure is generated wherein no salt bodies are identified. Such image is not compatible with acoustic field data (AD) as no salt bodies (SB) are located within the image but stratigraphically structure is being reproduced and artifacts have been removed avoiding a deteriorate process for the subsequent steps.

A further step salt bodies (SB) and regions being susceptible of appearing artifacts are generated in a specific manner by using the migration module (M).

A velocity correction Δv is determined by executing one or more iterations of the migration module (M). Migration module (M) computes Δv but does not update the image as the teachings of the prior art does.

Only D1 and D3 with no salt or artifacts regions are updated with the velocity correction Δv and, region D2 is only partially corrected by using a limited velocity correction Δv. Said limited velocity correction may be expressed as λΔv being λ∈(0,1).

Damping parameter λ limits the correction applied to region D2 avoiding the appearance of instabilities during the entire iterative process while it allows to converge to the solution according to the acoustic field data (AD).

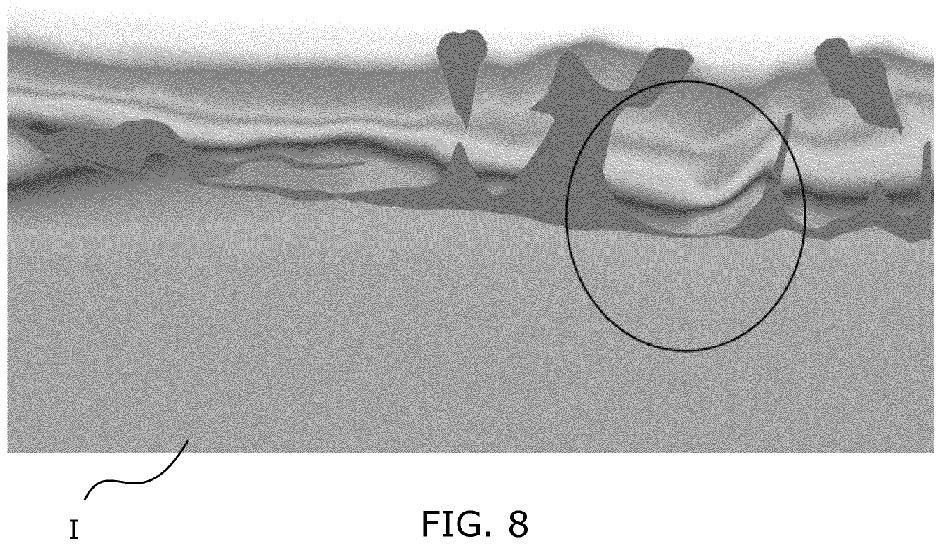

FIG. 8 shows the seismic image (I) obtained by carrying out:
the correction generation step and
the updating step with the limited value of the correction iteratively until convergence.

In a further embodiment the migration module (M) uses a ray stopper algorithm wherein the ray tracing prevents paths crossing the artifacts region D2 when migrating the image for computing the velocity correction. As overhangs provides regions located below that are susceptible of generating artifacts, an specific module (M) using a ray stopper algorithm wherein the ray tracing prevents paths crossing the artifacts region D2 uses acoustic information from the velocity field avoiding information sources causing instabilities.

The seismic image (I) obtained after convergence provides salt flanks, subsalt sediments, base of salt and pre-salt events continuous and focused.

According to a further embodiment, as the salt bodies (SB) are focused with a more accurate location, the entire method is repeated correcting the salt bodies (SB) location and their shape.

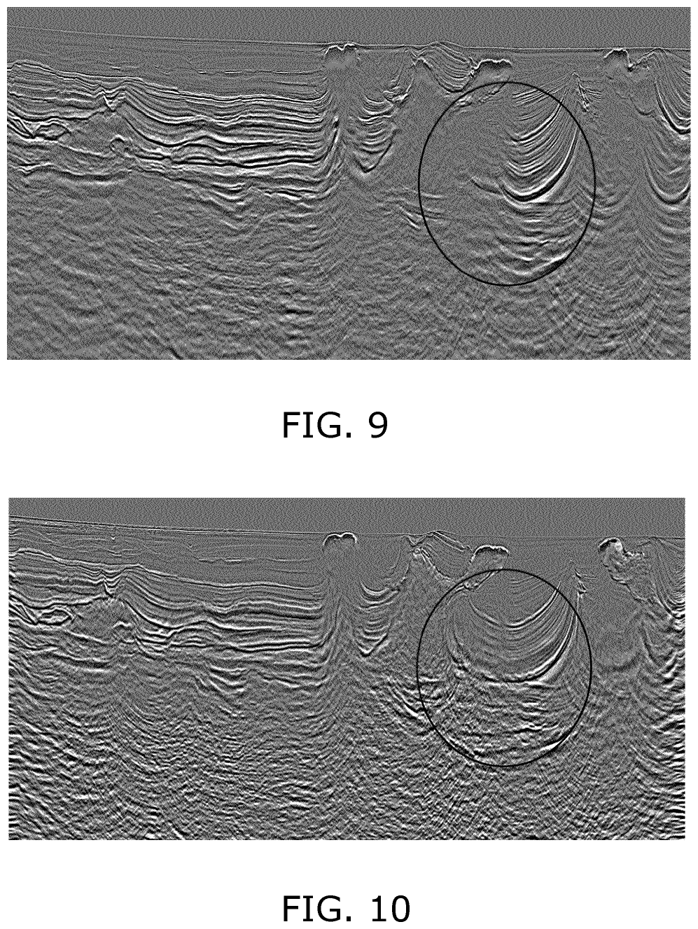

FIG. 9 shows an RTM section according to the initial image of FIG. 3. FIG. 10 is the same section migrated according to the method disclosed in this detailed embodiment where the oval encircles the region located below the overhang. The comparison clearly shows the more accurate representation of the velocity field with no instabilities.

1. A computer implemented method for improving a velocity model for seismic imaging, said method comprising a migration module configured to migrate acoustic field data to correct a seismic image iteratively, the seismic image comprising voxels and/or pixels representing a velocity model of a region of a subsurface region, wherein said migration module at least returns a velocity correction (Δv) of the seismic image by carrying out a predetermined number of iterations;
wherein the method comprises the steps:
a) recording seismic waves at the earth's surface being acquired as acoustic field data,
b) departing from an initial proposed image converting acoustic field data by the migration module, through a predetermined number of iterations, into an estimated seismic image comprising voxels and/or pixels representing the velocity model of the region of the subsurface region;
c) identifying in the seismic image at least one salt region D1, at least one artifacts region D2, and at least one region D3 with no salt or artifacts;
d) removing the voxels and/or pixels of the at least one salt region D1 and the at least one artifacts region D2 from the seismic image;
e) filling the at least one salt region D1 and the at least one artifacts region D2 of the seismic image with voxels and/or pixels with velocity values interpolated from the velocity values of the at least one region D3 with no salt or artifacts;
f) generating a velocity correction Δv for each voxel and/or pixel migrating the acoustic field data with the image obtained in step e) by means of the migration module carrying out a predetermined number of iterations n;
g) updating the at least one salt region D1 and the at least one region D3 with no salt or artifacts with the velocity correction Δv for each voxel and/or pixel of said regions;
h) updating the artifacts region D2 with a limited velocity correction Δv for each voxel and/or pixel of said regions, the limited velocity correction Δv being:
or a bounded velocity correction; that is, the correction Δv if |Δv|≥Δₘₐₓ being Δₘₐₓ a positive predetermined bound or the correction sign (Δv)·Δₘₐₓ if |Δv|≥Δₘₐₓ being sing (Δv) the sign of Δv,
or a damped velocity correction λΔv, being λ∈(0,1) a predetermined value.
i) providing the seismic image corrected in the previous step.

2. The method according to claim 1, wherein steps f)-h) are iteratively executed until convergence.

3. The method according to claim 1, wherein the at least one salt region D1, the at least one artifacts region D2, the at least one region D3 with no salt or artifacts, or any combination thereof are re-identified in the seismic image after the updating process according to step h).

4. The method according to claim 1, wherein in step e) the filling process of the at least one salt region D1, the at least one artifacts region D2, or both, comprises:
for each plane and/or row of voxels and/or pixels of the image comprising at least one voxel and/or pixel removed, interpolate the removed voxels and/or pixels by using the velocity values of voxels and/or pixels of the same plane and/or row corresponding to the at least one region D3 with no salt or artifacts.

5. The method according to claim 4, wherein it further comprises, after interpolating the removed voxels and/or pixels, a smoothing step involving voxels and/or pixels of the same plane and/or row.

6. The method according to claim 5, wherein the smoothing step is carried out by a Natural Neighbor algorithm.

7. The method according to claim 1, wherein after carrying out step e) and before carrying out step f), a smoothing step over the entire seismic image is applied.

8. The method according to claim 5, wherein the smoothing step over the entire seismic image is carried by:
generating a second image with the same number of voxels and/or pixels, each voxel and/or pixel having the value 1/v of the corresponding velocity value v of the voxel and/or pixel of the seismic image;
carrying out the smooth step over the second image;
providing the seismic image wherein each voxel and/or pixel takes the inverse value of the corresponding voxel and/or pixel of the second image.

9. The method according to claim 7, wherein the smoothing step over the entire image is carried out by a damped least square algorithm.

10. The method according to claim 1, wherein a union of the at least one salt region D1, the at least one artifacts region D2 and the at least one region D3 with no salt or artifacts is the entire image.

11. The method according to claim 1, wherein the artifacts region D2 comprises those voxels and/or pixels located under at least one salt region D1.

12. The method according to claim 1, wherein the migration module uses a ray stopper algorithm when carrying out the migration process in step f) wherein the ray tracing prevents paths crossing the artifacts region D2.

13. The method according to claim 1, wherein the at least one salt region D1 of the velocity model in step c) is identified selecting regions with velocity values within a prespecified range of velocity values measured in salt regions.

14. The method according to claim 1, wherein
the selection of artifacts regions D2,
the selection of the limited velocity correction Δv for the artifacts regions D2,
or any combination thereof are requested to the user.

15. A computer system having a processor and a non-transitory computer-readable medium storing computer-executable instructions which, when executed by the processor, cause the processor to carry out the method according to claim 1.

16. A non-transitory computer program product stored on a computer-readable medium and comprising computer-implementable instructions, which, when executed by a computer, cause the computer to carry out the method according to claim 1.
